(19) United States
(12) Patent Application Publication
(10) Pub. No.: US 2024/0286365 A1
(43) Pub. Date: Aug. 29, 2024

(54) METHOD FOR PRODUCING A COMPONENT AND COMPONENT HEREIN

(71) Applicant: Deutsches Zentrum für Luft- und Raumfahrt e.V., Bonn-Oberkassel (DE)

(72) Inventor: Lennert HEILMANN, Bremen (DE)

(21) Appl. No.: 17/633,382

(22) PCT Filed: Jul. 31, 2020
(86) PCT No.: PCT/EP2020/071684

§ 371 Date: Feb. 7, 2022

(30) Foreign Application Priority Data
Aug. 9, 2019 (DE) 10 2019 121 563.3

(51) Int. Cl. B29C 70/54; B29C 70/68; B29C 70/78; B29K 105/08

(52) U.S. Cl. CPC B29C 70/54; B29C 70/682; B29C 70/78; B29K 2105/08

(57) ABSTRACT

The invention relates to a method for producing a component from a component material, which comprises at least one plastics material, wherein the method comprises the following steps:
providing a component substrate, from which the component is intended to be produced;
applying a metal foil to the component substrate in at least one application portion;
consolidating the plastics material contained in the component substrate in such a way that the metal foil is connected to the consolidated plastics material in the application portion; and
peeling the metal foil off from the component substrate after the consolidation operation.

The invention relates to a method for producing a component from a construction material, which comprises at least one plastics material. The invention also relates to an associated component.

On account of the weight-specific strength and stiffness of fiber composite components, which are produced from a fiber composite material, it is nowadays virtually impossible not to conceive of such components in the aerospace sector and in many other fields of application, such as for example the automotive sector. During the production of a fiber composite component, a matrix material which embeds the fiber material is usually cured by exposure to temperature and pressure, and thus forms an integral unit with the fiber material after the curing operation. In this way, the reinforcing fibers of the fiber material are forced in their predefined direction and can dissipate the loads that occur in the predefined direction.

Fiber composite materials from which such fiber composite components are produced generally have two main constituents, namely a fiber material on the one hand and a matrix material on the other. It is additionally also possible for further secondary constituents to be used, such as for example binder materials or additional functional elements, which are intended to be integrated into the component. If dry fiber materials are provided for the production, then the production process involves infusing the matrix material of the fiber composite material into the fiber material by way of an infusion process, as a result of which the dry fiber material is impregnated with the matrix material. This generally takes place on account of a difference in pressure between the matrix material and the fiber material, for example by evacuating the fiber material by means of a vacuum pump. In contrast thereto, fiber composite materials in which the fiber material has already been pre-impregnated with the matrix material (so-called prepregs) are also known.

Prior to the curing of the matrix material, the fiber material is usually introduced into a forming tool, the shaping tool surface of which replicates the subsequent component form. In this case, it is possible for both dry and pre-impregnated fiber materials to be deposited or introduced into the forming tool.

In production, fiber composite components have some disadvantages compared with isotropic materials, since the component form of a fiber composite component generally has to be formed by corresponding forming tools which represents a type of negative impression of the subsequent component. It is therefore not uncommon for complex fiber composite components to be adhesively bonded together from various structural elements, either produced from fiber composite materials or composed of isotropic materials, in order to be able to produce the complex geometry.

Such fiber composite components are often also enhanced by lacquers and coatings, such that materials of this kind which are applied to such a finished fiber composite component have to be applied in a process-reliable manner and be reliably retained on the surface of such a fiber composite component. In this case, there is the fundamental need for coatings of this kind to also reliably adhere to the surface of the fiber composite component under given stress conditions.

Subsequently published DE 10 2018 111 306.4 has disclosed a method for applying a material to a surface of a fiber composite component, wherein prior to the application of the material, a woven monofilament fabric comprising matrix material is arranged on the component surface and is cured in a common process step together with the matrix material of the fiber composite component. After the curing operation, the woven monofilament fabric is peeled off from the component and the material is subsequently applied. The curing of the matrix materials produces a fixed connection in the boundary region between the component and the woven monofilament fabric, wherein the pulling off of the woven monofilament fabric has the effect of cohesively fracturing the matrix material in the boundary region.

US 2013/0280488 A1 has disclosed a method for producing a fiber composite component, wherein in order to prepare a joining surface, a bond ply and a peel ply are applied to the fiber composite component. After the curing operation, the bond ply and the peel ply are removed from the component, as a result of which the joining surface of the component is activated for a further application step.

However, the use of woven peel fabric as a method for surface activation entails a fundamental contradiction, which lies in the requirements imposed. On the one hand, the pulling off of the woven fabric is intended to generate a cleaner, activated surface. On the other hand, the woven fabric is intended to be able to be pulled off manually without a high expenditure of force, it being necessary to not damage the component in the process.

It has furthermore been shown that epoxy resins which were in contact with thermoplastic materials of the woven peel fabric during the curing operation are not very wettable and not very adhesive after the thermoplastic material has been removed. Owing to new findings, it can be assumed that an interaction between the molecules of the organic thermoplastic and the monomers of the epoxy resin in the curing operation is the reason for the poor wettability and bondability.

A further disadvantage of conventional woven peel fabric is that the components are often stored or transported (e.g. from overseas) for a relatively long period of time before the further process step is carried out. Since the woven peel fabric that is typically used does not constitute a diffusion barrier, moisture can diffuse into the components through the woven peel fabric, and so said components have an impermissibly high moisture content at the time of processing. It is therefore often necessary to subject the components to a re-drying operation prior to the application of further materials.

It is therefore an object of the present invention to specify an improved method for producing a component, in particular a fiber composite component, by means of which improved surface activation for the application of further materials can be achieved.

The object is achieved according to the invention by means of the method as claimed in claim 1, the component as claimed in claim 14 and the peel film/foil as claimed in claim 15. Advantageous embodiments of the invention can be found in the corresponding claims.

In claim 1, a method for producing a component from a component material which comprises at least one plastics material is claimed, wherein a component substrate is firstly provided, from which the component is intended to be produced. In this case, the component substrate may for example be composed of the plastics material, without including any further fiber materials. The component substrate may alternatively comprise the fiber material of a fiber composite material, but without also including the required matrix material at the time of provision. Said matrix material is only infused into the fiber material of the component substrate at a later point in time. It is alternatively possible for the component substrate to comprise the fiber material and the matrix material which embeds the fiber material.

Furthermore, at least one peel film/foil is provided which has a metallic or ceramic surface at least on an application side. After the component substrate and the at least one peel film/foil have been provided, the metallic or ceramic application side of the peel film/foil is applied to the component substrate in at least one application portion, in order to protect the surface of the component substrate in the application portion against contamination and the ingress of moisture during storage and transport and to prepare, and in particular activate, it for subsequent processing processes.

The plastics material contained in the component substrate is then consolidated against the peel film/foil applied in the application portion, more specifically against the metallic or ceramic surface of the application side of the peel film/foil, in order to cohesively and/or adhesively connect the peel film/foil to the consolidated plastics material in the application portion. Here, in the context of the present invention, consolidation of the plastics material is understood to mean that the plastics material is at least partially cured. However, it is also conceivable for the plastics material to be completely cured, that is to say the polymerization processes of the plastics material are largely at an end in this case. This is also understood to mean the solidification of a plastics material without undergoing a chemical reaction, if said plastics material has previously been liquefied, for example.

Finally, according to the invention, the peel film/foil is then peeled off or removed (for example in the form of a pulling-off operation) from the component substrate after the consolidation step, with the result that the thus formed surface of the component substrate has been correspondingly prepared and activated for further application step.

The peeling-off process can be carried out manually or mechanically, it being possible for the peel force to be measured in the case of a mechanical peeling-off operation, which enables enhanced quality control and process monitoring.

It has been shown that the use of a woven peel fabric having a metallic or ceramic application surface (for example an in particular commercially available metal foil) for the activation of surfaces of a plastics component, in particular of a fiber composite component, produces a very good surface quality, without the disadvantages known from the prior art when using conventional woven peel fabric. This also makes it possible to maintain uniform material properties and a uniform cleanliness in a significantly improved manner compared with conventional peel fabric without metallic or ceramic application surfaces.

The inventor has furthermore recognized that in particular commercially available metal foils can be used as woven peel fabric in a generic production method for plastics components. In this case, surprisingly, it has in particular been determined that thin metal foils of this kind, after the cohesive and/or adhesive connection to the plastics material, can also be peeled off by means of a pull-off force which damages neither the metal foil nor the component.

Here, the peel film/foil may be composed of or comprise in particular aluminum, stainless steel, copper, nickel, titanium, or other alloys. In the case of a peel film/foil, in particular a metal foil, which comprises or is formed from aluminum, it is advantageous if said film/foil has a thickness of 50 to 350 μm. In the case of steel, it is advantageous if the peel film/foil has a thickness of 20 to 200 μm. In particular, the application side of the peel film/foil is free of adhesion-inhibiting residues which could remain on the component surface after the peeling-off operation and thus would hamper the subsequent application process. The peel film/foil is in particular not a woven fabric or textile-like structure.

One side or both sides of the peel film/foil may preferably comprise a metal oxide layer (e.g. aluminum oxide or chromium oxide). One side or both sides of the peel film/foil may have a surface enhancement, for example etching, blasting, anodizing, passivation, etc. (in particular on the application side).

In the most cost-effective case, the peel film/foil is a commercially available metal foil in the form of a roll good, which is provided in an unfinished form. The correspondingly required portions are cut to length, cut to size and applied to the component.

One side or both sides of the peel film/foil may preferably comprise a protective film/foil or a protective paper, as a result of which the cleanliness of the application surface is ensured. Unintentional contamination of the surface during transport, storage and processing can be avoided by the protection. The protection is removed directly before the application.

The plastics material may for example be materials based on epoxide (epoxy resin), thermosets (e.g. polyether, epoxy resins, vinyl ester, unsaturated polyester, phenol resins, etc.), thermoplastics and/or elastomers.

As already mentioned, the peel film/foil may be a pure metal foil or ceramic film, which has been or is produced in a metallic or ceramic rolling process, for example. In this case, the carrier material of the peel film/foil and the application side are jointly formed from the metallic or ceramic material. The metal foil is accordingly composed predominantly of a metal material, and the ceramic film is accordingly composed predominantly of a ceramic material.

According to one embodiment, it is alternatively possible for the application side of the peel film/foil to be provided with a metallic or ceramic coating. In this exemplary embodiment, the carrier material of the peel film/foil is specifically not a metal material or ceramic material, but rather a material that differs therefrom, for example a plastics material (the carrier material is a plastics film in this case). In this case, the carrier material of the peel film/foil is coated on the application side with a metallic or ceramic material by way of a coating process, and so a metallic or ceramic surface is formed.

According to one embodiment, it is provided that the component material used is a fiber composite material, which comprises a fiber material and a matrix material as plastics material which embeds the fiber material, in order to produce a fiber composite component. Here, the component substrate may be a fiber preform composed of fiber material, the peel film/foil being applied to a fiber preform composed of dry fiber materials or pre-impregnated fiber materials. When using dry fiber materials, the dry fiber materials are subsequently infused with matrix material in an intermediate step. In this case, the matrix material makes contact with the applied peel film/foil.

For consolidation purposes, a vacuum system is created above the component substrate after the metal foil has been applied, in order to evacuate the component substrate and possibly to infuse the matrix resin. The component substrate is then cured under the vacuum system by temperature control and possibly exposure to pressure.

It has been shown that the use of a peel film/foil, for example a metal foil, as woven peel fabric under a vacuum system for the production of a fiber composite component leads to the desired improved results.

According to one embodiment, it is provided that at least one material is applied in the application portion after the metal foil has been peeled off. In this case, such a material may preferably be an adhesive, wherein after the adhesive has been applied, at least one further component is adhesively bonded in the application portion by means of the adhesive. The peeling off of the peel film/foil thus has the effect of activating the component surface and pretreating it for the joining operation to be performed thereon. The joining partner may be a lacquer or a coating. The material to be applied (for example adhesive, lacquer, coating) should be applied promptly after the peeling-off operation since the surface reactivity decreases over time.

However, the material to be joined may also be a fiber composite material, in which case no separate adhesive layer is applied. Rather, the adhesive connection to the component surface which is activated by the peeling off of the peel film/foil is produced by the matrix material of the composite material. To this end, the fiber composite material is applied in the form of an uncured prepreg to the pretreated surface or applied in the form of dry fiber material and subsequently infused with matrix material. During the consolidation of the matrix material, the adhesive connection is produced by the curing matrix material.

According to one embodiment, it is provided that a separating material is introduced between the substrate and the peel film/foil in at least one region of the application portion, in order to prevent the peel film/foil from connecting to the substrate in this region. This region may for example be an edge region of the peel film/foil, with the result that the peel film/foil can be detached in this region in a particularly easy manner after the plastics material has been consolidated. A tab is thus produced, with the aid of which the peel film/foil can be peeled off from the component substrate.

According to one embodiment, it is provided that a peel film/foil is provided which has at least one linear predetermined breaking point, or that at least one linear predetermined breaking point is produced in the peel film/foil, with the result that a plurality of segments are produced, wherein the peel film/foil is peeled off from the component substrate segment by segment by severing of the linear predetermined breaking point. What is achieved by the presence of such a predetermined breaking point is that the peel film/foil can be applied to the component substrate in one piece and then be peeled off in strips. One possible production method is the rolling-in of notches at uniformly distributed distances over the film/foil width, which constitute a material weakening of the peel film/foil and thus predefine the profile of the tear during the strip-like peeling-off operation. In this case, a separating material may be introduced between the peel film/foil and the substrate at one end of each segment, in order to form a pull-off tab for each segment.

However, according to one embodiment, it is alternatively conceivable for a peel film/foil to be provided which has a plurality of individual segments which have been connected to one another by means of a common carrier material on a rear side of the segments, said rear side facing away from the component substrate, or for a plurality of individual segments to be connected to one another by means of a common carrier material on a rear side facing away from the component substrate, wherein the segments are peeled off from the component substrate by severing of the carrier material between two segments. In this embodiment, the peel film/foil is composed of individual segments which are separate and separated from one another, the segments being connected to one another by means of a common carrier material. Here, too, a situation is achieved where the peel film/foil can be applied to the component substrate in one piece, it then being possible for the individual segments to be peeled off in a strip-like manner (peeling off segment by segment). The individual and separate segments may lie flush against one another or alternatively may be arranged so as to overlap.

According to one embodiment, it is provided that a peel film/foil is provided which has a reinforcing layer on a rear side facing away from the component substrate, or in that a reinforcing layer is applied to a rear side of the peel film/foil, said rear side facing away from the component substrate. In a particular embodiment associated with this, it may be provided that the reinforcing layer is an areal reinforcing textile. In this case, the reinforcing layer comprises a material that differs from the material of the peel film/foil. However, it is also conceivable for the peel film/foil to be provided entirely without a reinforcing layer.

In this case, the peel film/foil may be a sheet-like structure which is produced in a rolling process and which makes contact with the reinforcing layer. However, it is also conceivable for the metal to be applied in the form of a metal layer or metal oxide layer to the reinforcing layer in a chemical, electrochemical or physical deposition process. If the reinforcing layer is a plastics film, it may be metalized on one or both sides, that is to say a thin, continuous metal coating or metal oxide coating is applied by way of a deposition process.

If the metal layer is produced by way of a deposition process, the connection between the reinforcing layer and the metallization is implemented in such a way that the construction can be peeled off from the component surface in a residue-free manner. Thus, no metallic particles remain on the component surface after the peeling process.

In this case, the reinforcing layer or the areal reinforcing textile makes contact with the peel film/foil. The areal reinforcing textile may for example be a woven fabric, knitted fabric or a nonwoven. The reinforcing layer or the areal reinforcing textile may be applied loosely and be connected to the peel film/foil during the subsequent processing process, for example by way of impregnation with matrix material. However, the reinforcing layer or the areal reinforcing textile may also have already been fixedly connected to the peel film/foil at the time of provision of said peel film/foil. The reinforcing layer or the areal reinforcing textile may be adhesively bonded to the rear side of the peel film/foil, in the case of this connection has sufficient flexibility so as to also be able to drape the peel film/foil onto a complex surface geometry. After the curing of the plastics material against the peel film/foil, said peel film/foil together with the reinforcing layer or the areal reinforcing textile can be peeled off from the component substrate. In this case, the reinforcing layer or the areal reinforcing textile provides the peel film/foil with an increased strength and prevents the initiation of tearing of the peel film/foil, wherein, at the same time, the flexibility of the peel film/foil remains unchanged, and so it can be easily peeled off. In this case, the reinforcing layer may be formed, for example, from a plastics layer or plastics film composed of a thermoset, thermoplastic or elastomer.

According to one embodiment, it is provided that a peel film/foil is provided which has a functional coating on the application side facing the component substrate, or in that a functional coating is applied to the application side of the peel film/foil, said application side facing the component substrate. In a particular embodiment associated with this, it may be provided that after the peel film/foil has been peeled off, the coating at least partially remains on the component substrate and performs further functions.

Here, the coating may for example be an adhesion-promoting substance which gives rise to a fracture profile in the plastics material, for example in the matrix material of the fiber composite material, when the peel film/foil is being peeled off. However, it may also be a coating which completely or partially remains on the component substrate and the subsequent component, that is to say that during the peeling-off operation the coating itself may cohesively fracture or else detach completely from the peel film/foil. The coating may have such a colored design that it differs from the color of the component substrate or subsequent component. This is advantageous for subsequent joining operations, in order to identify the joining zone. At the same time, the coating material that remains on the component substrate may perform particular functions. For instance, owing to a material heterogeneity, the coating may give rise to crack-arresting properties in an adhesive bond implemented thereon.

In one embodiment, it is provided that a peel film/foil is provided which has a structuring, in particular a microstructuring, or in that such a structuring, in particular a microstructuring, is produced. In this case, the structuring can in particular be provided in such a way, or is produced in such a way, that a structured surface is produced on the component substrate after the peel film/foil has been peeled off. In this case, the structuring may be provided or produced on the application side facing the component substrate. Here, the peel film/foil may have a microstructuring in such a way that it produces a type of form fit (micro-form fit) with the plastics material, said form fit producing a cohesive fracture component on the surface of the plastics material during the peeling-off operation.

In this case, such a structuring may have been or be formed such that unevennesses and/or complex geometries (multiply curved) of the surface of the component substrate can be covered with the peel film/foil in an areal manner. In this case, the structuring forms a material reservoir, with the aid of which the peel film/foil can be stretched to a certain extent. It is thus possible for unevennesses to be compensated, since the peel film/foil can also be placed down in depressions or over elevations in a planar manner. The material reservoir is thus used to provide additional film/foil material in order to compensate for unevennesses in the application portion of the component substrate. In this case, the structuring is preferably effected in the direction of that side of the peel film/foil which faces away from the component substrate.

Advantageously, the peel film/foil may have one or more holes or perforations, which serve to allow excess plastics material, in particular matrix material in an infusion process, to escape. Ideally, the openings or holes are so small that plastics material which has passed therethrough cohesively fractures when the metal foil is being peeled off. An impression of the material located over the metal foil is undesirable in the region of the holes, since otherwise a surface is produced which has uneven regions, which are potentially not well suited for an adhesive bonding process.

After the peeling-off operation, the component surface may have elevations in the region of the holes, the height of said elevations being dependent on the hole diameter and the specific construction of the film/foil. The embodiment of the film/foil can be used to adjust the height of the elevations and the number and distribution of the raised portions in accordance with the requirement of the subsequent joining process. When coating or lacquering the component, a small height of the elevations may be desirable, which is obtained in particular by way of a small hole diameter. In the case of a subsequent process for joining with a further component, however, relatively large raised portions, typically in the range of between 100 μm and 300 μm for structural bonds, may be desirable. These elevations can be used as spacers between the two components, with the result that the adhesive applied between the components has a set and precisely defined adhesive layer thickness. In the case of a joining process under pressure, a situation where too much of the applied adhesive is pressed out of the joining zone and the required adhesive layer thickness is fallen below is in particular prevented by the elevations. Rather, the second component can be pressed against the first component until it makes contact with the resin-rich elevations of the first component. An adhesive layer thickness with the height of the elevations is thus ensured.

Advantageously, in order to peel the peel film/foil off from the component substrate in a simple manner, the peel film/foil may be folded over in a U-shaped manner in at least one edge region. The upper part of the folded-over region thus does not make contact with the plastics material and can be used as a pull-off tab subsequent to the consolidation. In the edge region, it is also possible for special elements to be applied to the top side of the peel film/foil in order to be able to start the peeling operation.

Advantageously, the peeling off of the peel film/foil leads to an adhesive fracture between the peel film/foil and the plastics material, or else to a cohesive fracture close to the surface. In both cases, good bondability of the surface is ensured.

The peel film/foil may be cut in an edge portion so that the metal foil can be peeled off from the component in strips, which reduces the expenditure of force.

Several portions of a peel film/foil can be applied next to one another, it being possible for the portions to overlap.

The peel film/foil can be applied to the component substrate in a large-area manner or else only in particular regions in which a joining operation with corresponding materials is subsequently intended to be carried out. If the peel film/foil is only applied in particular limited application portions, dry or pre-impregnated woven peel fabric can be applied to the remaining regions of the component substrate. In this case, the woven peel fabric is omitted in the application portion of the peel film/foil or else the woven peel fabric is arranged over the peel film/foil. It is thus also possible to produce a fixed connection between the woven peel fabric and the rear side of the peel film/foil, as a result of which the peel film/foil can also simultaneously be peeled off when the woven peel fabric is subsequently being peeled off.

During the production of fiber composite components by means of a forming tool, the metal foil may be arranged on a shaping tool surface of the forming tool. However, it is also conceivable for the metal foil to be applied on an open side of the component substrate, which does not face the forming tool.

Moreover, the object is also achieved according to the invention by means of the component as claimed in claim 14, wherein the component comprises a plastics material and is produced in accordance with the method described above. The component may for example be a fiber composite component, which is produced from a fiber composite material comprising a fiber material and a matrix material which embeds the fiber material. In this case, the plastics material on the film/foil may be identical to the matrix material of the component to be consolidated, or else may deviate therefrom in terms of the chemical formulation.

Moreover, the object is also achieved according to the invention by means of the peel film/foil as claimed in claim 15 for use in the method described above, wherein the peel film/foil has, on an application side facing the component substrate, a layer composed of in particular uncured plastics material. By means of this layer of plastics material, the peel film/foil is then applied to the application portion of the component substrate and the plastics material is consolidated, such that the peel film/foil is connected to the plastics material of the component substrate via the plastics material.

In this case, the peel film/foil may be a metal foil or ceramic film. However, it is also conceivable for the peel film/foil to have a film/foil-like carrier material which is provided with a metallic or ceramic coating on the application side.

Advantageous embodiments of the metal foil can be found in the corresponding subclaim.

The invention will be explained in more detail by way of example on the basis of the attached figures, in which:

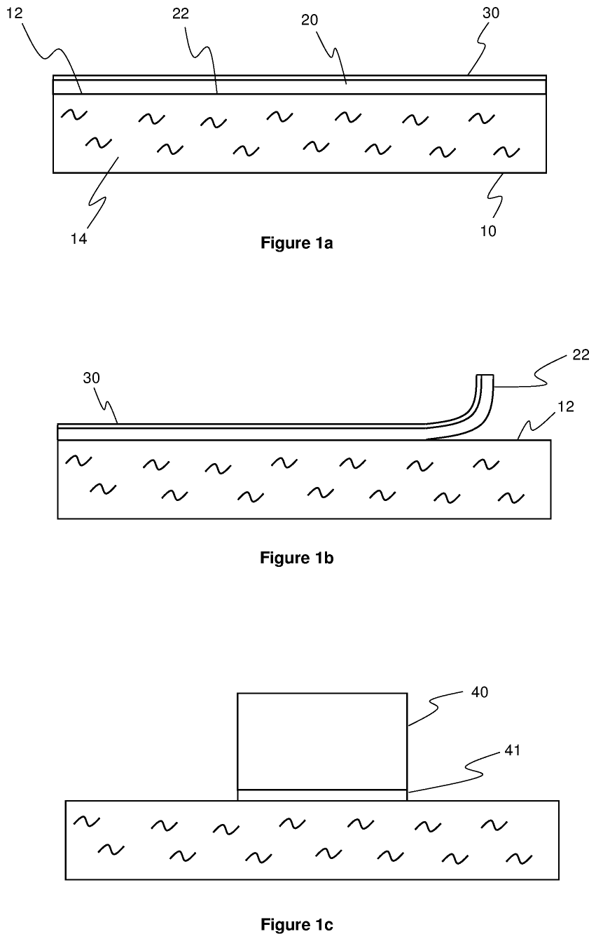

FIGS. 1a-c show a schematic illustration of the method sequence;

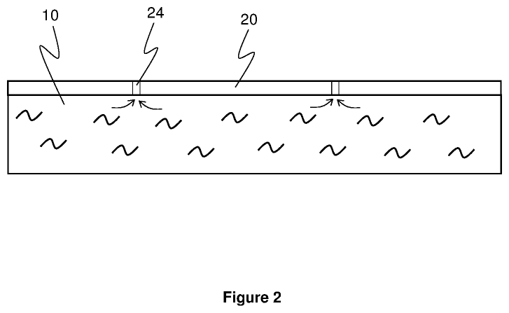

FIG. 2 shows a schematic illustration of one embodiment;

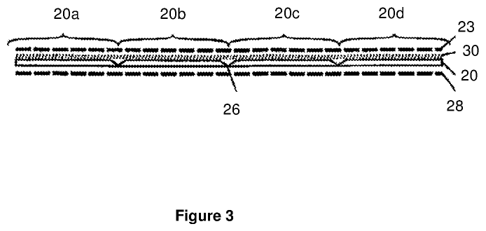

FIG. 3 shows a schematic illustration of a cross section of a metal foil in a particular embodiment;

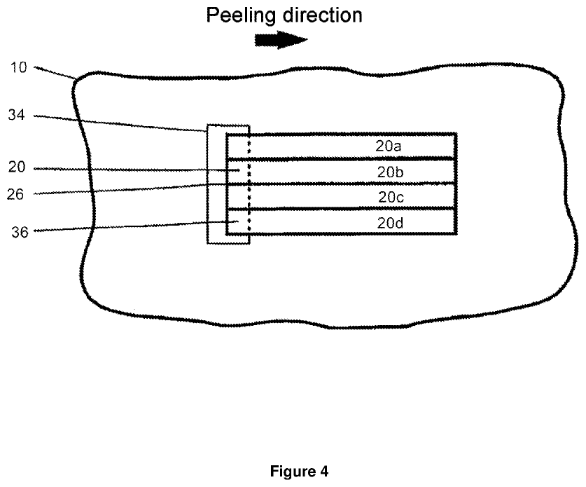

FIG. 4 shows a schematic illustration of a plan view of a segmented metal foil.

In the following exemplary embodiments, the peel film/foil is a pure metal foil. However, the described exemplary embodiments can also be implemented using other films/foils.

The method sequence of the present invention is schematically shown in FIGS. 1a to 1c. Here, FIG. 1a shows a component substrate 10 which, in the exemplary embodiment of FIG. 1a shown, may for example be a fiber composite component which has not yet been completely consolidated. Consequently, the component substrate 10 may be a fiber preform which is formed either of dry fiber material or of pre-impregnated fiber material.

A metal foil 20 has been applied to the provided component substrate 10 within an application portion 12 of the component substrate 10, in order to prepare the surface of the application portion 12 for a subsequent joining operation.

Furthermore, a reinforcing textile 30, which does not hamper the flexible nature of the metal foil 20 and which is intended to bolster the tear resistance of the metal foil 20 when said metal foil is being pulled off or peeled off, is arranged on the metal foil 20.

After the metal foil 20 together with the reinforcing textile 30 has then been applied to the application portion 12 of the component substrate 10, the plastics material 14 contained in the component substrate 10 is consolidated or cured. If the component substrate 10 has been provided in the form of dry fiber materials, the plastics material 14 can be infused in the form of a matrix material into the component substrate 10 in an infusion process (not illustrated), and wets and makes contact with the application side 22 of the metal foil 20 during the infusion. In the case of pre-impregnated fiber materials, the application side 22 of the metal foil 20 would be applied directly to, and thus makes contact with, the plastics material 14 already contained in the fiber material.

After the plastics material 14 has been consolidated, which may mean at least partial curing of the plastics material 14 or complete curing of the plastics material 14, the metal foil 20, as shown in FIG. 1b, is peeled off from the application portion 12 of the component substrate 10. The molecules of the plastics material 14, for example an epoxy resin, make contact with a metal or a metal oxide, which is known for its relatively high surface energy. In this case, it is assumed that the reactive groups of the plastics material are aligned in the direction of the metal foil and remain in this orientation as a result of the consolidation. If the metal foil 20 is subsequently peeled off and removed, the adhesive bond between the plastics material 14 and the metal foil 20 is broken. The surface thus generated comprises reactive groups which are oriented in the direction of the surface and are available for the formation of new adhesive bonds, e.g. with an applied adhesive or lacquer.

Here, if a relatively smooth metal foil 20 (for example bolstered by an oxide layer) is used, the bond between the plastics material 14 and the metal foil 20 is weak such that the metal foil 20 can be pulled off with a small expenditure of force. In this case, it has been shown that the adhesively fractured surface of the component substrate 10 is then also still reactive, has a high surface energy and is readily wettable.

If the bond between the plastics material 14 and the metal foil is strong, a relatively high expenditure of force is required during the pulling-off operation. This can ultimately result in a partially or even completely cohesively fractured surface of the consolidated plastics material 14, said surface likewise being very well suited for subsequent adhesive operations since the cohesive fracture leads to free radicals at the surface. Such a relatively strong bond between the plastics material 14 and the metal foil 20 can be obtained, for example, by a microstructuring of the metal foil 20 (formation of micro-form fit) or by surface activation of the metal surface.

After the metal foil 20 has been peeled off from the component substrate 10, it is then possible, as shown in FIG. 1c, for a further component 40 to be adhesively bonded to the thus activated surface of the application portion 12 by means of an adhesive layer 41. If an unconsolidated fiber composite component is adhesively bonded and is consolidated during the adhesive bonding process, the adhesive 41 may also be matrix material of the fiber composite component.

FIG. 2 shows an exemplary embodiment in which openings 24 have been provided in the metal foil 20, with the result that excess plastics material (identified by the arrows) can be discharged through the openings 24. The excess plastics material may for example be absorbed by means of a woven fabric which is applied over the perforated metal foil.

FIG. 3 shows a schematic illustration of an embodiment of a metal foil 20 which has, on its lower application side 22, a protective film/foil 28 for protection against contamination. The reinforcing textile 30 is provided on the opposite side, a protective paper 32 being arranged on the reinforcing textile 30. In this configuration, the metal foil 20 can be rolled up on a roll or core in the form of roll goods.

The metal foil 20 comprises a plurality of predetermined breaking points 26 in the form of rolled-in notches which are used to form a desired and predefined material weakening in this regions. In this way, the total metal foil is divided into a multiplicity of metal foil segments 20a-20d, as a result of which the metal foil can be applied to the component substrate in one piece, but can be peeled off therefrom segment by segment.

This is shown schematically by way of example in FIG. 4. In this case, a separating film/foil 34, which is intended to prevent the metal foil 20 from connecting to the plastics material of the component substrate 10, is located in one region, with the result that a pull-off tab 36 can be formed for each individual segment. This makes it possible for each segment to be successively peeled off from the component substrate 10, with the metal foil 20 tearing at the predefined predetermined breaking points 26.

### LIST OF REFERENCE SIGNS

10 Component substrate
12 Application portion
14 Plastics material
20 Metal foil
20a-d Metal foil segments
22 Application side of the metal foil
24 Openings in the metal foil
26 Predetermined breaking point
28 Protective film/foil
30 Reinforcing textile
32 Protective paper
34 Separating film/foil for pull-off tab
36 Pull-off tab

1. A method for producing a component from a component material which comprises at least one plastics material, wherein the method comprises:
providing a component substrate, from which the component is intended to be produced, the component substrate containing a plastics material;
providing at least one peel film/foil which has a metallic or ceramic surface at least on an application side;
applying the application side of the at least one peel film/foil to the component substrate in at least one application portion;
consolidating the plastics material contained in the component substrate in such a way that the metallic or ceramic surface of the at least one peel film/foil is connected to a consolidated plastics material in the at least one application portion; and
peeling the at least one peel film/foil off from the component substrate after the consolidating step.

2. The method as claimed in claim 1, wherein the at least one peel film/foil is provided as a metal foil or ceramic film, or wherein the at least one peel film/foil is provided with a metallic or ceramic coating provided on the application side.

3. The method as claimed in claim 1 wherein the component material is a fiber composite material which comprises a fiber material and a matrix material, and wherein the plastics material embeds the fiber material to produce the fiber composite component.

4. The method as claimed in claim 1 wherein at least one material is applied in the at least one application portion after the at least one peel film/foil has been peeled off.

5. The method as claimed in claim 4, wherein the at least one applied material is an adhesive, wherein after the adhesive has been applied, at least one further component is adhesively bonded in the at least one application portion by the adhesive.

6. The method as claimed in claim 1 further comprising introducing a separating material between the component substrate and the at least one peel film/foil in at least one region of the at least one application portion, in order to prevent the at least one peel film/foil from connecting to the component substrate in the at least one region.

7. The method as claimed in claim 1 wherein the at least one peel film/foil has at least one linear predetermined breaking point, or wherein at least one linear predetermined breaking point is produced in the at least one peel film/foil, with a result that a plurality of segments are produced, wherein the at least one peel film/foil is peeled off from the component substrate segment by segment of the plurality of segments by severing of the at least one linear predetermined breaking point.

8. The method as claimed in claim 1 wherein the at least one peel film/foil has a plurality of individual segments which are connected to one another by a common carrier material on a rear side of each of the plurality of segments, said rear side facing away from the component substrate, or wherein a plurality of individual segments are connected to one another by a common carrier material on a rear side facing away from the component substrate, wherein each of the plurality of segments are peeled off from the component substrate by severing of the carrier material between two segments of the plurality of segments.

9. The method as claimed in claim 1 wherein the at least one peel film/foil has a reinforcing layer on a rear side facing away from the component substrate, or wherein a reinforcing layer is applied to a rear side of the at least one peel film/foil, said rear side facing away from the component substrate.

10. The method as claimed in claim 9, wherein the reinforcing layer is an areal reinforcing textile.

11. The method as claimed in claim 1 wherein the at least one peel film/foil has a functional coating on the application side facing the component substrate, or wherein a functional coating is applied to the application side of the at least one peel film/foil, said application side facing the component substrate.

12. The method as claimed in claim 11, wherein the at least one peel film/foil is peeled off, and wherein the coating at least partially remains on the component substrate and performs further functions.

13. The method as claimed in claim 1 wherein the at least one peel film/foil has a structuring, or wherein a structuring is produced in the at least one peel film/foil.

14. A component produced by a method as claimed in claim 1.

15. A peel film/foil configured for use in a method as claimed in claim 1, comprising a metallic or ceramic surface at least on an application side and a layer of plastics material on the application side facing a component substrate.

16. The peel film/foil (20) as claimed in claim 15, further comprising at least one of the following features:
at least one linear predetermined breaking point configured such that a plurality of segments are produced, wherein the peel film/foil is peel offable from the component substrate segment by segment of the plurality of segments by severing of the at least one linear predetermined breaking point;
a plurality of segments which have been connected to one another by a common carrier material on a rear side of the plurality of segments, said rear side facing away from the component substrate, wherein each of the plurality of segments is peel offable from the component substrate by severing of the carrier material;
a reinforcing layer on a rear side facing away from the component substrate;
a functional coating on the application side facing the component substrate; and/or
a structuring on the application side facing the component substrate such that after the peel film/foil has been peeled off, a structured surface is produced on the component substrate.

17. The method of claim 13 wherein the structuring is a microstructuring.
